(19) United States
(12) Patent Application Publication
(10) Pub. No.: US 2024/0334969 A1
(43) Pub. Date: Oct. 10, 2024

(54) ULTRASONIC ATOMIZER, AND ULTRASONIC ATOMIZATION DEVICE

(71) Applicant: SHENZHEN FIRST UNION TECHNOLOGY CO., LTD., Shenzhen, Guangdong Province (CN)

(72) Inventors: Yongqiang LIU, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/701,643

(22) PCT Filed: Nov. 4, 2022
(86) PCT No.: PCT/CN2022/130032

§ 371 Date: Apr. 21, 2024

(30) Foreign Application Priority Data
Nov. 5, 2021 (CN) 202111304436.6

(51) Int. Cl. A24F 40/05; A24F 40/10; A24F 40/42; A24F 40/44; A24F 40/48; B05B 17/06

(52) U.S. Cl. CPC A24F 40/05; A24F 40/10; A24F 40/42; A24F 40/44; A24F 40/48; B05B 17/06

(57) ABSTRACT

An ultrasonic atomizer and an ultrasonic atomization device are provided. The ultrasonic atomizer includes a housing internally provided with a liquid storage cavity; a liquid guide element; an ultrasonic atomization sheet including an atomization surface and configured to ultrasonically atomize a liquid substrate absorbed by the liquid guide element to generate an aerosol; and a sealing member configured to seal at least a part of the liquid storage cavity, where the sealing member is further configured to stay in contact with at least a part of the liquid guide element and abut the at least a part of the liquid guide element against the atomization surface. In the ultrasonic atomizer, the sealing member of the liquid storage cavity is utilized to directly abut against the liquid guide element, so that the liquid guide element can be in close contact with the atomization surface of the ultrasonic atomization sheet.

### CROSS-REFERENCE TO RELATED APPLICATIONS

This application claims priority to Chinese Patent Application No. 202111304436.6, entitled “ULTRASONIC ATOMIZER AND ULTRASONIC ATOMIZATION DEVICE” and filed with the China National Intellectual Property Administration on Nov. 5, 2021, which is incorporated herein by reference in its entirety.

### TECHNICAL FIELD

This application relates to the field of ultrasonic atomization technologies, and in particular, to an ultrasonic atomizer and an ultrasonic atomization device.

### BACKGROUND

An ultrasonic atomizer includes an ultrasonic atomization sheet, and the ultrasonic atomization sheet is provided with micropores. When the ultrasonic atomization sheet oscillates at a high frequency, a liquid substrate in the micropores may be atomized to generate liquid vapor, and the liquid vapor is sprayed from the micropores to be inhaled by a user.

An existing ultrasonic atomizer abuts a flexible e-liquid guide medium against the ultrasonic atomization sheet through a compression spring or a glass fiber tube, so that good contact is kept between the flexible e-liquid guide medium and the ultrasonic atomization sheet. Problems existing in the ultrasonic atomizer are as follows: an internal design of the ultrasonic atomizer is complex, and material and assembly costs thereof are relatively high. In addition, glass fiber catkins generated by the glass fiber tube can easily cause severe damage to a human body.

### SUMMARY

An aspect of this application provides an ultrasonic atomizer, including a housing, where the housing is internally provided with:
a liquid storage cavity, configured to store a liquid substrate;
a liquid guide element, configured to be in fluid communication with the liquid storage cavity to absorb the liquid substrate;
an ultrasonic atomization sheet, including an atomization surface, where the ultrasonic atomization sheet is configured to ultrasonically atomize the liquid substrate the liquid guide element to generate an aerosol; and
a sealing member, configured to seal at least a part of the liquid storage cavity, where the sealing member is further configured to stay in contact with at least a part of the liquid guide element and abut the at least a part of the liquid guide element against the atomization surface.

Another aspect of this application provides an ultrasonic atomization device, including a power supply assembly and the ultrasonic atomizer.

In the ultrasonic atomizer, the sealing member of the liquid storage cavity is utilized to directly abut against the liquid guide element, so that the liquid guide element can be in close contact with the atomization surface of the ultrasonic atomization sheet. Therefore, an additional cotton pressing element is not required, and a structure cooperating with the additional cotton pressing element also does not need to be designed in the sealing member, thereby saving material costs and assembly costs. In addition, since the sealing member is elastic, the liquid guide element elastically abuts against the atomization surface of the ultrasonic atomization sheet, so that the sealing member and the liquid guide element do not cause damage to the ultrasonic atomization sheet when the ultrasonic atomization sheet oscillates at a high frequency.

### BRIEF DESCRIPTION OF THE DRAWINGS

One or more embodiments are exemplarily described with reference to the corresponding figures in the accompanying drawings, and the descriptions do not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an ultrasonic atomization device according to an implementation of this application;

FIG. 2 is a schematic diagram of another ultrasonic atomization device according to an implementation of this application;

FIG. 3 is a schematic diagram of an ultrasonic atomizer according to an implementation of this application;

FIG. 4 is a schematic exploded view of an ultrasonic atomizer according to an implementation of this application;

FIG. 5 is a schematic exploded view of an ultrasonic atomizer from another perspective according to an implementation of this application;

FIG. 6 is a schematic cross-sectional view of an ultrasonic atomizer according to an implementation of this application;

FIG. 7 is another schematic cross-sectional view of an ultrasonic atomizer according to an implementation of this application;

FIG. 8 is a schematic diagram of a first liquid guide element according to an implementation of this application;

FIG. 9 is a schematic diagram of a second liquid guide element according to an implementation of this application;

FIG. 10 is a schematic diagram of a sealing member according to an implementation of this application;

FIG. 11 is a schematic diagram of a sealing member from another perspective according to an implementation of this application; and

FIG. 12 is a schematic diagram of an ultrasonic atomization assembly according to an implementation of this application.

### DETAILED DESCRIPTION

For ease of understanding of this application, this application is described in further detail below with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

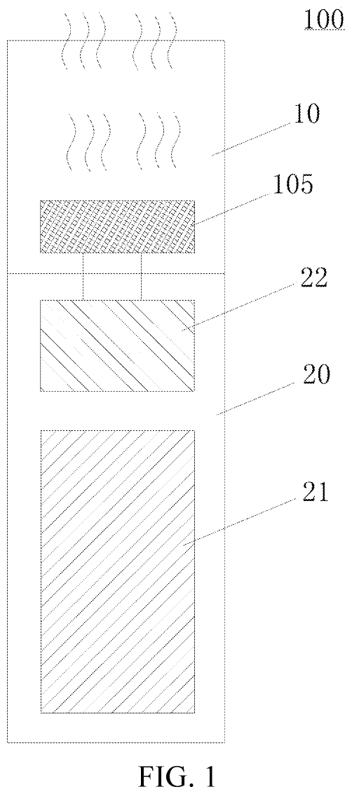

FIG. 1 is a schematic diagram of an ultrasonic atomization device according to an implementation of this application.

As shown in FIG. 1, the ultrasonic atomization device 100 includes an ultrasonic atomizer 10 and a power supply assembly 20, and the ultrasonic atomizer 10 and the power supply assembly 20 are non-detachable.

The ultrasonic atomizer 10 includes an ultrasonic atomization assembly 105, and the ultrasonic atomization assembly 105 oscillates at a high frequency with power supplied by the power supply assembly 20, to atomize a liquid substrate into an aerosol.

The power supply assembly 20 includes a battery cell 21 and a circuit 22.

The battery cell 21 provides power for operating the ultrasonic atomization device 100. The battery cell 21 may be a rechargeable battery cell or a disposable battery cell.

The circuit 22 may control overall operations of the ultrasonic atomization device 100. The circuit 22 not only controls operations of the battery cell 21 and the ultrasonic atomization assembly 105, but also controls operations of other elements in the ultrasonic atomization device 100.

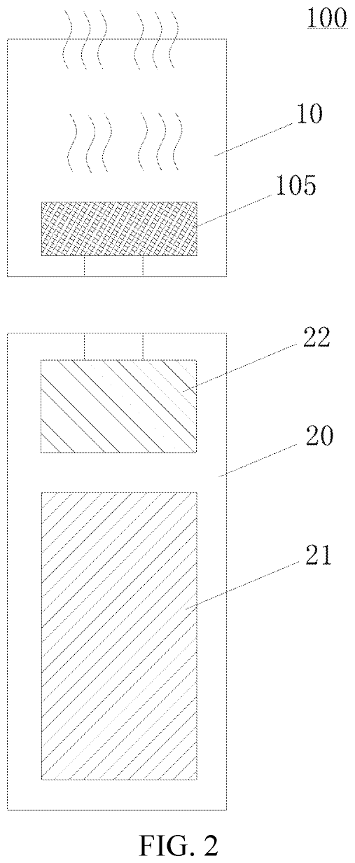

FIG. 2 is a schematic diagram of another ultrasonic atomization device according to an implementation of this application. Different from the example in FIG. 1, the ultrasonic atomizer 10 is detachably connected to the power supply assembly 20.

For ease of description, the following examples are described only by using an example in which the ultrasonic atomizer 10 is detachably connected to the power supply assembly 20.

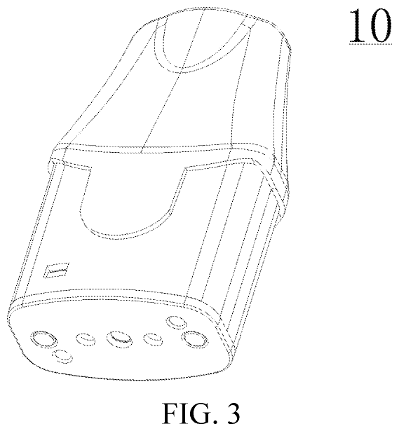

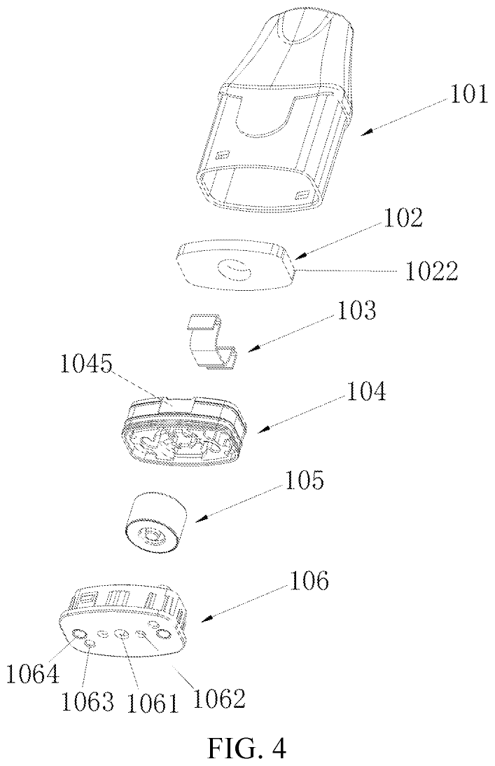

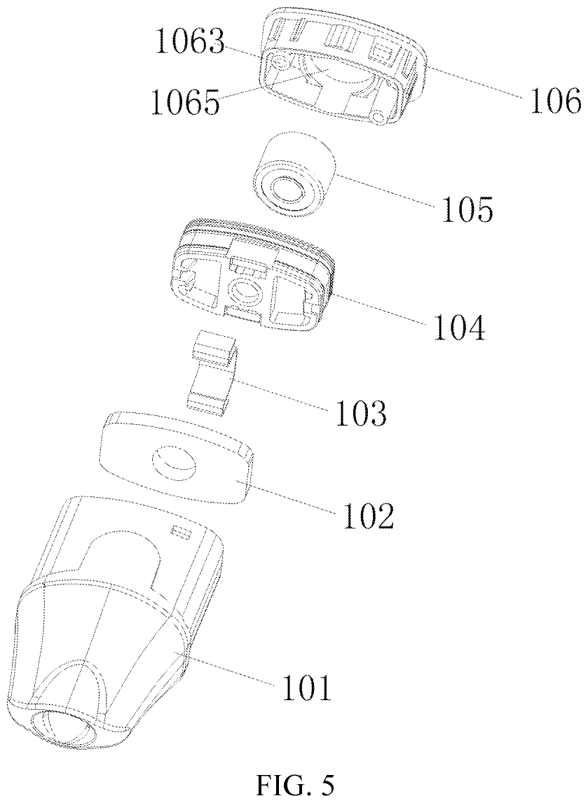

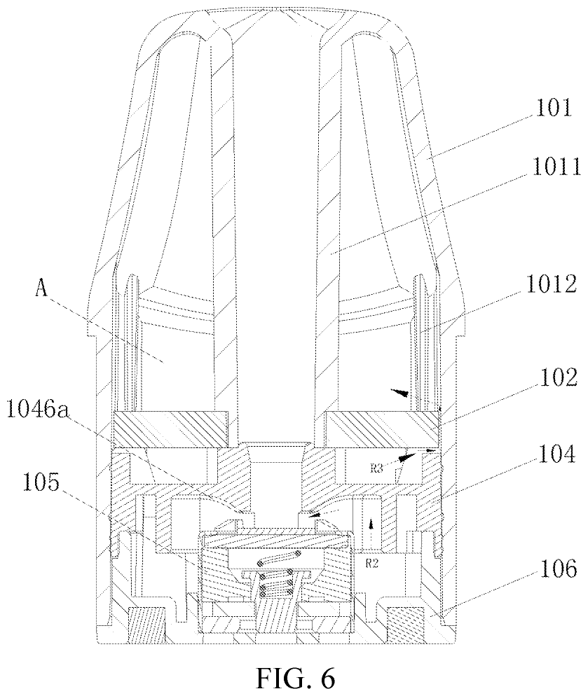

As shown in FIG. 3 to FIG. 7, the ultrasonic atomizer 10 includes:

a main body 101, which is roughly in a shape of a flat cylinder. The main body 101 includes a proximal end and a distal end that are opposite to each other along a length direction; the proximal end is configured as an end for a user to inhale aerosols, and a suction nozzle for the user to inhale is arranged at the proximal end; and the distal end is used as an end combined with the power supply assembly 20, and the distal end of the main body 101 is an opening on which a detachable bottom cap 106 is installed. After being combined with the bottom cap 106, the main body 101 and the bottom cap 106 jointly define a housing of the ultrasonic atomizer 10, and the housing is internally hollow and provided with necessary functional devices configured to store and atomize the liquid substrate. Various necessary functional components may be installed inside the housing of the ultrasonic atomizer 10 through the opening of the main body 101.

A first electrode hole 1061 and a second electrode hole 1062 are provided on the bottom cap 106. Through the first electrode hole 1061 and the second electrode hole 1062, the ultrasonic atomization assembly 105 may form an electrical connection to the power supply assembly 20. In addition, an air inlet 1063 is further provided on the bottom cap 106, for external air to enter the ultrasonic atomizer 10 during inhalation. Further, an accommodating chamber 1065 is further provided on the bottom cap 106, the first electrode hole 1061 and the second electrode hole 1062 are both located in the accommodating chamber 1065, and the air inlet 1063 is located outside the accommodating chamber 1065. Further, a magnetic connector 1064 is further arranged on the bottom cap 106, so that the ultrasonic atomizer 10 is detachably connected to the power supply assembly 20.

The housing is internally provided with a liquid storage cavity A configured to store the liquid substrate, a liquid guide element 102 (a first liquid guide element) configured to absorb the liquid substrate from the liquid storage cavity A, a liquid guide element 103 (a second liquid guide element) configured to absorb the liquid substrate, a sealing member 104, and the ultrasonic atomization assembly 105 for ultrasonically atomizing the liquid substrate. As the case shown by the liquid guide element 102 and the liquid guide element 103, the liquid guide element may be formed by combination of a plurality of independent components, and a specific number of the independent components is set according to a specific liquid guide requirement, which may be two, three, or more than three. In some embodiments, the liquid guide element may alternatively be one independent component.

A vapor output tube 1011 is arranged along an axial direction inside the main body 101, and a space between an outer wall of the vapor output tube 1011 and an inner wall of the main body 101 forms the liquid storage cavity A configured to store the liquid substrate; and an end of the vapor output tube 1011 is in communication with the suction nozzle, to transmit the generated aerosol to the suction nozzle for inhalation. In a preferred implementation, the vapor output tube 1011 and the main body 101 are integrally molded by a moldable material, so that the liquid storage cavity A formed after preparation is in a form of an opening toward the distal end.

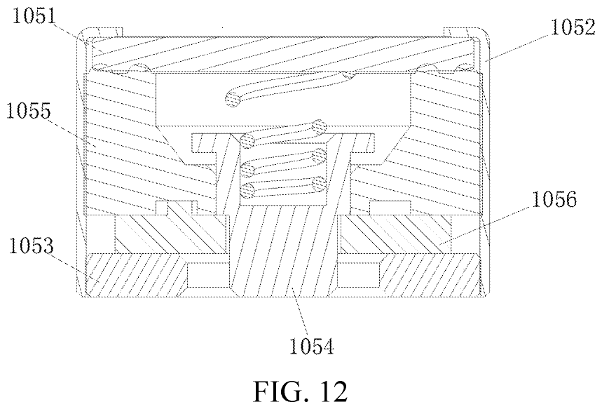

Referring to FIG. 12, the ultrasonic atomization assembly 105 includes an ultrasonic atomization sheet 1051, a first electrical connector (1052, 1053), a second electrical connector 1054, an insulating sealing member 1055, and a resistive plate 1056.

The ultrasonic atomization sheet 1051 is roughly in a shape of a circle with a first electrode formed on an upper surface (or an atomization surface) and a second electrode formed on a lower surface. The first electrical connector (1052, 1053) stays in contact with the first electrode to form an electrical connection. The second electrical connector 1054 stays in contact with the second electrode to form an electrical connection.

The first electrical connector (1052, 1053) includes a conductive sleeve 1052 and a coupling member 1053. The ultrasonic atomization sheet 1051, the second electrical connector 1054, the insulating sealing member 1055, and the resistive plate 1056 are all arranged in the conductive sleeve 1052. The ultrasonic atomization sheet 1051 is horizontally arranged adjacent to an upper end of the conductive sleeve 1052, so that the first electrode stays in contact with the conductive sleeve 1052 to form an electrical connection; an end of the coupling member 1053 and an end of the second electrical connector 1054 are both arranged flush with each other and adjacent to a lower end of the conductive sleeve 1052; the resistive plate 1056 is electrically connected and arranged between the coupling member 1053 and the second electrical connector 1054; and the insulating sealing member 1055 is sleeved on the second electrical connector 1054 and arranged between the resistive plate 1056 and the ultrasonic atomization sheet 1051.

The insulating sealing member 1055 may be made by a silicone material.

The resistive plate 1056 may consume energy stored by the ultrasonic atomization sheet 1051 after the ultrasonic atomization sheet is powered on and then powered off, to ensure that the ultrasonic atomization sheet 1051 can work normally after being powered on again, thereby avoiding the ultrasonic atomization sheet 1051 from releasing a transient high voltage after being powered on again and burning out other electronic elements.

After assembly, the ultrasonic atomization assembly 105 is partially accommodated in the accommodating chamber 1065, the first electrode hole 1061 and the second electrical connector 1054 are provided coaxially, and the second electrode hole 1062 and the coupling member 1053 are provided opposite to each other.

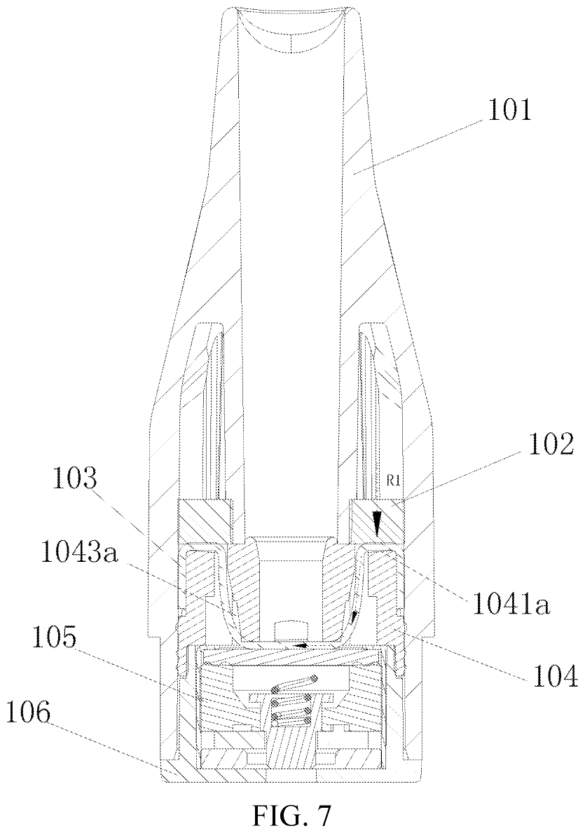

The liquid guide element 102 is a layer of sheet-shaped or block-shaped organic porous fiber extending along a cross section direction of the main body 101. After assembly, an upper surface of the liquid guide element 102 that is adjacent to the liquid storage cavity A is opposite to the liquid storage cavity A and is configured to absorb the liquid substrate, and a lower surface that faces away from the liquid storage cavity A transmits the liquid substrate to the liquid guide element 103 that is in contact with the lower surface, as shown by an arrow R1 in FIG. 7. An insertion hole for the vapor output tube 1011 to run through is provided on the liquid guide element 102.

In a preferred implementation, the liquid guide element 102 is prepared by an elastic organic porous material, which presents proper flexibility and rigidity. During implementation, the liquid guide element 102 has elastic modulus or rigidness that is smaller than that of a material of the main body 101 or defining the liquid storage cavity A and greater than or equal to that of a material of the liquid guide element 103. Specifically, the liquid guide element may be hard artificial cotton having a Shore hardness ranging from 20 A to 70 A. In an optional implementation, the liquid guide element 102 includes polymer cotton of polyester fiber, polymer cotton or artificial foam of filamentous polyurethane, or the like. The liquid guide element 102 has hardness or flexibility between that of common flexible plant cotton/non-woven fabrics (a Shore hardness is less than 20 A) and that of rigid porous ceramics/microporous metal (a Shore hardness is greater than 80 A), so that a structure is stable and has extremely low expansion after the liquid guide element absorbs and is saturated by the liquid substrate. After assembly, contact between the liquid guide element 102 and the inner wall of the main body 101 or a tube wall of a vapor output tube 11 is between flexible contact and rigid contact, so that the flexibility of the liquid guide element may independently seal the liquid storage cavity A, and due to the specific hardness, the liquid guide element may be easily fixed and kept. Specifically, as shown in the figure, a shape of the liquid guide element 102 matches the opening at a lower end of the liquid storage cavity A, so that the liquid guide element may be further configured to cover, block, and seal the liquid storage cavity A. In a more preferred implementation, the liquid guide element 102 has a Shore hardness ranging from 50 A to 70 A, which is approximately equivalent to a thermoplastic elastic body or silicone.

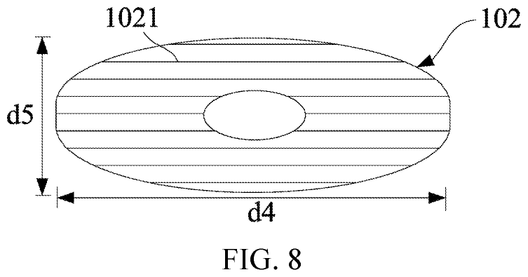

FIG. 8 shows a schematic diagram of morphology of a surface or a cross section of a liquid guide element 102 having the foregoing hardness. The liquid guide element 102 is roughly in a shape of an ellipse, and the insertion hole matching the vapor output tube 1011 is also in a shape of an ellipse. The liquid guide element 102 is prepared by, for example, aligned fiber of polyethylene and/or polypropylene that is basically aligned along a length direction, so that the liquid guide element 102 presents a strong anti-bending force and further presents a hard feature through arrangement of the aligned fiber along the length direction of the liquid guide element 102. In addition, when the liquid guide element 102 is prepared by using the foregoing organic fiber, a sufficient gap is reserved between fiber materials during preparation, so that the liquid substrate can be transmitted, and the liquid guide element 102 can have suitable flexibility. The liquid guide element 102 prepared by the foregoing aligned fiber is anisotropic. Specifically, on one hand, an anti-bending strength of the liquid guide element along the length direction is greater than an anti-bending strength along a width direction; or on the other hand, a liquid guide rate of the liquid guide element along the length direction is greater than a liquid guide rate along the width direction.

Besides, in FIG. 8, a texture 1021 extending along the length direction exists on a surface of or inside the liquid guide element 102. Specifically, the texture 1021 is prepared by the foregoing aligned fiber through a textile process such as roller pressing. In addition, distances between some fiber are enlarged through roller pressing or a hydroentanglement process during preparation, so that dents visible to naked eyes are formed at locations where the distances are enlarged, where a width of each dent is less than 1 mm and approximately ranges from 0.1 mm to 0.5 mm. Further, the dents form the texture 1021 on the surface of or inside the liquid guide element 102, which is beneficial to transmission and keeping of the liquid substrate and improvement on the hardness performance.

In the liquid guide element 102 shown in FIG. 8 in the foregoing embodiment, the liquid guide element 102 has a length d4 of 16.4 mm, a width d5 of 7.8 mm, and a thickness of 2 mm.

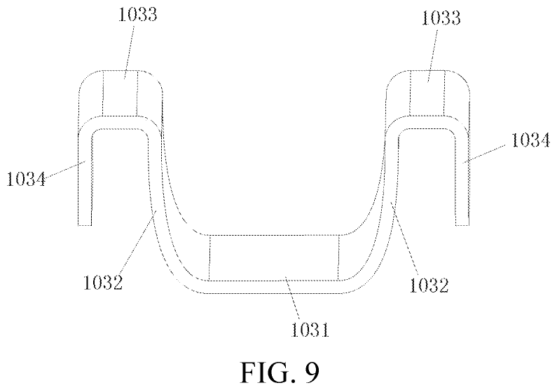

As shown in FIG. 9, the liquid guide element 103 is prepared by a flexible strip-shaped or rod-shaped fiber material, such as cotton fiber, non-woven fiber, or sponge. During assembly, the liquid guide element 103 is constructed to be special-shaped (approximately a bilaterally symmetrical structure), including a first part 1031 extending along a width direction of the main body 101, second parts 1032 extending from two ends of the first part 1031 toward the liquid storage cavity A along a longitudinal direction of the main body 101, third parts 1033 extending from one ends of the second parts 1032 along the width direction of the main body 101, and fourth parts 1034 extending from one ends of the third parts 1033 away from the liquid storage cavity A along the longitudinal direction of the main body 101. During use, the third part 1033 is in contact with a lower surface of the liquid guide element 102, to absorb the liquid substrate from the liquid guide element 102 and transfer the liquid substrate to the second part 1032 through capillary saturation, to further transmit the liquid substrate to the first part 1031. It should be noted that, in other examples, the liquid guide element 103 may be formed by a plurality of separate parts.

In the foregoing ultrasonic atomizer, the liquid substrate is absorbed from the liquid guide element 102 by the liquid guide element 103, so that e-liquid explosion caused when the liquid substrate is excessively or excessively quickly transmitted to the ultrasonic atomization sheet 1051 can be prevented.

In order to assemble and fix the liquid guide element 103 and the liquid guide element 102, the main body 101 is further internally provided with a sealing member 104 configured to seal at least a part of the liquid storage cavity A.

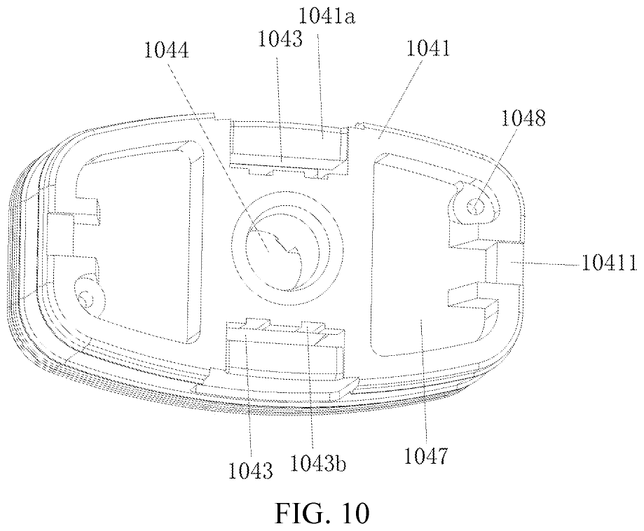

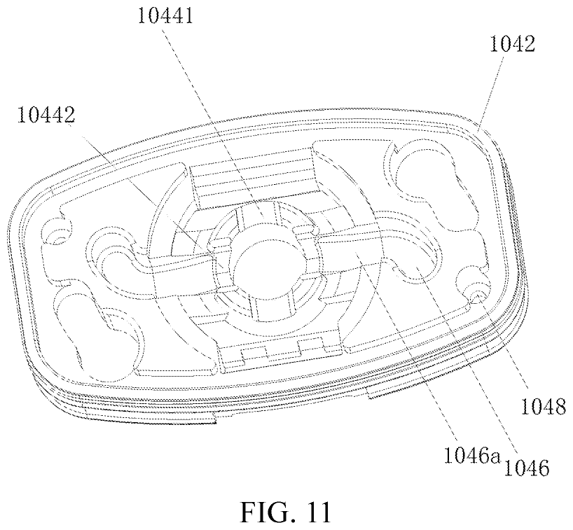

Specifically, as shown in FIG. 10 and FIG. 11, the sealing member 104 includes a first end portion 1041 and a second end portion 1042 that are opposite to each other along a longitudinal direction of the main body 101. The first end portion 1041 is arranged adjacent to the liquid storage cavity A, and the second end portion 1042 is arranged adjacent to the bottom cap 106. After assembly, the first end portion 1041 abuts against the lower surface of the liquid guide element 102 to at least partially keep the liquid guide element 102; and the second end portion 1042 is kept on the ultrasonic atomization assembly 105 and the bottom cap 106.

The sealing member 104 is symmetrically provided with a pair of through holes 1043 along a thickness direction of the main body 101, and the through holes 1043 are in fluid communication with the liquid storage cavity A. That is, in addition to sealing the part of the liquid storage cavity A, the sealing member 104 may further cause the liquid substrate of the liquid storage cavity A to be transmitted to the first part 1031 of the liquid guide element 103 only through the through holes 1043. A vapor channel 1044 formed through run-through hollow is further provided between the through holes 1043. The vapor channel 1044 includes a proximal end adjacent to the liquid storage cavity A and an opposite distal end.

After assembly, the first part 1031 of the liquid guide element 103 is kept on the atomization surface of the ultrasonic atomization sheet 1051, the second part 1032 extends in the through hole 1043, the third part 1033 is kept on the first end portion 1041, and the fourth part 1034 is kept between a peripheral side wall 1045 of the sealing member 104 and the inner wall of the main body 101. The distal end of the vapor channel 1044 stays in contact with the first part 1031 and abuts the first part 1031 against the atomization surface of the ultrasonic atomization sheet 1051. Compared with the solution of the glass fiber tube in the existing technology, while the elastic contact with the ultrasonic atomization sheet 1051 is ensured, the distal end of the vapor channel 1044 directly abuts the first part 1031 against the atomization surface of the ultrasonic atomization sheet 1051, so that no step needs to be arranged on an inner wall of the vapor channel 1044 to keep the glass fiber tube. Therefore, the inner wall of the vapor channel 1044 is roughly flat.

In a preferred implementation, an end portion of the distal end of the vapor channel 1044 is partially or locally recessed to form a notch groove 10441, and the first part 1031 and/or the second part 1032 are/is arranged along the notch groove 10441. Through the notch groove 10441, good combination between the liquid guide element 103 and the ultrasonic atomization sheet 1051 can be ensured, and transmission of the liquid substrate to the ultrasonic atomization sheet 1051 is also facilitated.

In a preferred implementation, an inner wall of the through hole 1043 is provided with an inclined surface 1043a that is arranged adjacent to the first part 1031 and inclines toward the outside of the through hole 1043. In some embodiments, the inner wall of the through hole 1043 is provided with a step surface arranged adjacent to the first part 1031 or another structure arranged to enlarge a space adjacent to the first part 1031 in the through hole. Through the design of the inclined surface 1043a or the step surface, an avoidance space is formed at an end (adjacent to the first part 1031) of the through hole 1043, to avoid an excessively slow e-liquid flowing speed caused by the liquid guide element 103 tightly clamped due to inward deformation when the sealing member 104 is squeezed, so that the liquid substrate can smoothly flow to the first part 1031.

The third part 1033 is kept on a part of the first end portion 1041, and the part of the first end portion 1041 forms a keeping portion. In a preferred implementation, the keeping portion includes a surface that matches a shape of the third part 1033 and faces the liquid storage cavity A, to keep the third part 1033. In a further preferred implementation, the keeping portion includes an inclined surface 1041a that inclines toward a direction away from the third part 1033 or toward the through hole 1043, that is, inclines toward the bottom cap 106; and the inclined surface 1041a may prevent the third part 1033 from being tightly clamped by the liquid guide element 102 and the sealing member 104 and causing an excessively slow e-liquid flowing speed, so that the liquid substrate can smoothly flow to the second part 1032 or the through hole 1043.

In some embodiments, a liquid absorbing section of the liquid guide element is supported through the inclined surface of the sealing member 104, so that the liquid absorbing section can stay in close contact with an e-liquid outlet of the liquid storage cavity or another liquid guide element. A first objective is to prevent a problem that the liquid substrate cannot be transmitted to the atomization surface through the liquid guide element caused by offsetting of the liquid absorbing section from the e-liquid outlet when the ultrasonic atomizer 10 oscillates at a high frequency or the atomizer is moved. A second objective is to prevent a problem of liquid substrate leakage caused by an excessively large gap existing between the e-liquid outlet of the liquid storage cavity and the liquid guide element. In some embodiments, the liquid absorbing section of the liquid guide element may be the third part 1033 described above, or may be a part that plays a liquid absorbing function in the liquid guide element. In some embodiments, the inclined surface of the sealing member 104 may be the inclined surface 1041a described above.

Preferably, the sealing member 104 is prepared by a flexible material such as silicone or a thermoplastic elastic body. During implementation, a convex rib extending along a circumferential direction is arranged on the peripheral side wall 1045 of the sealing member 104, and the convex rib is configured to seal a gap between the sealing member 104 and the inner wall of the main body 101.

In a preferred implementation, a liquid buffer space may be provided on the sealing member 104, to store the liquid substrate so as to adjust the efficiency of transmitting the liquid substrate to the ultrasonic atomization sheet 1051. For example, a capillary trench 1043b may be provided on a part of the inner wall of the through hole 1043 that is adjacent to the liquid storage cavity A (it should be noted that, the capillary trench may replenish air into the liquid storage cavity A simultaneously, to alleviate negative pressure caused by consumption of the liquid substrate in the liquid storage cavity A); or a window or a hollow part surrounding the second part 1032 is arranged on the peripheral side wall 1045 of the sealing member 104, so that the second part 1032 is at least partially exposed to the sealing member 104, and a blocking space is further formed, to prevent the liquid substrate from flowing or being transmitted to the first part 1031 quickly.

In an air path design for releasing and outputting an aerosol, the inner wall of the vapor channel 1044 and the atomization surface of the ultrasonic atomization sheet 1051 jointly define an atomization chamber; and a cross section of the vapor channel 1044 is smaller than a cross section of the vapor output tube 1011, and an other end of the vapor output tube 1011 is sleeved on the proximal end of the vapor channel 1044. In this way, the aerosol obtained through ultrasonically atomizing is outputted through the vapor channel 1044 and the vapor output tube 1011.

In a preferred implementation, an airflow guide portion 1046 that is obliquely arranged relative to the atomization surface is further arranged on the sealing member 104, and an end portion of the distal end of the vapor channel 1044 is partially or locally recessed to form an airflow groove 10442, to form an airflow outlet of the airflow guide portion 1046. During inhalation, external air flows into the ultrasonic atomizer 10 through the air inlet 1063 on the bottom cap 106, and flows into the ultrasonic atomizer through an air inlet of the airflow guide portion 1046 and changes a direction to flow out from the airflow groove 10442 into the vapor channel 1044 or toward the atomization surface (as shown by R2 in the figure), and the air and the aerosol obtained through ultrasonically atomizing are together outputted along the vapor channel 1044 and the vapor output tube 1011.

In a further preferred implementation, the airflow guide portion 1046 includes an airflow guide surface 1046a that obliquely extends from the airflow groove 10442 toward a direction out of the main body 101 or a direction away from the airflow channel 10442, so that the airflow with a direction changed may flow out from the airflow groove 10442 into the vapor channel 1044 in a preset angle. In this way, through the airflow guide portion 1046 including the airflow guide surface 1046a, the air may flow out toward the atomization surface of the ultrasonic atomization sheet 1051, which is beneficial to mixture of the air and atomized particles, thereby improving inhalation experience.

In a further preferred implementation, a thickness (or a wall thickness) of the end portion of the distal end of the vapor channel 1044 ranges from 0.5 mm to 1 mm. Preferably, the thickness ranges from 0.5 mm to 0.8 mm. Further preferably, the thickness ranges from 0.6 mm to 0.8 mm. Through setting of the thickness, a strength of the end portion of the distal end of the vapor channel 1044 is ensured, and a problem that a portion of the end portion of the distal end of the vapor channel 1044 that stays in contact with the first part 1031 is bent outward and deformed when the ultrasonic atomization sheet 1051 oscillates at a high frequency is avoided.

Along an extension direction from the distal end toward the proximal end of the vapor channel 1044, a thickness (or a wall thickness) of the vapor channel 1044 may be consistent or inconsistent. In a further preferred implementation, along the extension direction from the distal end toward the proximal end of the vapor channel 1044, the thickness of the vapor channel 1044 is gradually increased, and an inner diameter of the vapor channel is basically consistent. In this way, the setting is beneficial to transmission of the atomized aerosol, and the setting further ensures a strength of the vapor channel 1044, so that a problem that the portion of the end portion of the distal end of the vapor channel 1044 that stays in contact with the first part 1031 is bent outward and deformed when the ultrasonic atomization sheet 1051 oscillates at a high frequency is avoided. It may be understood that, the thickness of the entire vapor channel 1044 may be gradually increased along the extension direction; or the thickness in some sections may be gradually increased along the extension direction. For example, the thickness of a lower part of the vapor channel 1044 is gradually increased, and thickness of an upper part may be consistent.

In a further preferred implementation, the ultrasonic atomizer 10 further includes an air channel for air to enter the liquid storage cavity A, to replenish air into the liquid storage cavity A so as to alleviate negative pressure caused by consumption of the liquid substrate in the liquid storage cavity A.

Specifically, during implementation, a part of the first end portion 1041 of the sealing member 104 that is adjacent to the lower surface of the liquid guide element 102 is recessed to form a groove 1047, an airflow hole 1048 that is in fluid communication with the groove 1047 is further provided on the sealing member 104, and a notch groove 10411 that is in fluid communication with the groove 1047 is further provided on the first end portion 1041.

A gap exists between a peripheral side wall extending between the upper and lower surfaces of the liquid guide element 102 and the inner wall of the main body 101, and the gap forms a first channel part of the air channel. The first channel part basically extends along the longitudinal direction of the main body 101. In a preferred implementation, a convex edge 1012 is arranged on the inner wall of the main body 101, and the convex edge 1012 abuts against the liquid guide element 102, so that the gap is kept between the liquid guide element 102 and the inner wall of the main body 101 to form the first channel part. Further, the peripheral side wall extending between the upper and lower surfaces of the liquid guide element 102 includes a flat-straight part 1022 adjacent to the convex edge 1012, and the flat-straight part 1022 abuts against the convex edge 1012 to keep the gap between the liquid guide element 102 and the inner wall of the main body 101.

The groove 1047 forms a second channel part of the air channel, and the airflow hole 1048 forms a third channel part of the air channel. An upper end surface of the airflow hole 1048 is higher than a bottom surface of the groove 1047. Through the groove 1047 provided on the sealing member, the air permeability between the upper and lower surfaces of the liquid guide element 102 is ensured while the negative pressure in the liquid storage cavity A is alleviated, which is beneficial to transmission of the liquid substrate. Further, the groove 1047 may buffer the liquid substrate, which is beneficial to preventing liquid leakage.

The convex rib arranged on the peripheral side wall 1045 of the sealing member 104 seals the gap between the sealing member 104 and the inner wall of the main body 101. In this way, during use, when the negative pressure in the liquid storage cavity A is gradually increased as the liquid substrate is consumed, the air flowing from the air inlet 1063 into the ultrasonic atomizer 10 may flow into the groove 1047 only through the airflow hole 1048, and then flow to the liquid storage cavity A through the notch groove 10411 and the gap between the liquid guide element 102 and the inner wall of the main body 101 (as shown by R3 in the figure), to alleviate the negative pressure in the liquid storage cavity A and ensure smooth transmission of the liquid substrate.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application.

Further, a person of ordinary skill in the art may make improvements or modifications according to the foregoing description, and all the improvements and modifications shall fall within the protection scope of the appended claims of this application.

1. An ultrasonic atomizer, comprising a housing, wherein the housing is internally provided with:
a liquid storage cavity, configured to store a liquid substrate;
a liquid guide element, configured to be in fluid communication with the liquid storage cavity to absorb the liquid substrate;
an ultrasonic atomization sheet, comprising an atomization surface, wherein the ultrasonic atomization sheet is configured to ultrasonically atomize the liquid substrate absorbed by the liquid guide element to generate an aerosol; and
a sealing member, configured to seal at least a part of the liquid storage cavity, wherein the sealing member is further configured to stay in contact with at least a part of the liquid guide element and abut the at least a part of the liquid guide element against the atomization surface.

2. The ultrasonic atomizer according to claim 1, wherein the sealing member has run-through hollow to form a vapor channel, and the vapor channel comprises a first end and a second end opposite to the first end; and
an end portion of the second end stays in contact with the at least a part of the liquid guide element, to abut the at least a part of the liquid guide element against the atomization surface.

3. The ultrasonic atomizer according to claim 2, wherein an inner wall of the vapor channel and the atomization surface jointly define an atomization chamber.

4. The ultrasonic atomizer according to claim 2, wherein an inner wall of the vapor channel is roughly flat.

5. The ultrasonic atomizer according to claim 2, wherein the end portion of the second end is locally recessed to form a notch groove.

6. The ultrasonic atomizer according to claim 2, wherein the end portion of the second end is locally recessed to form an airflow groove.

7. The ultrasonic atomizer according to claim 2, wherein a thickness of the end portion of the second end ranges from 0.5 mm to 1 mm.

8. The ultrasonic atomizer according to claim 2, wherein a thickness of the vapor channel is gradually increased along an extension direction facing the first end from the second end.

9. The ultrasonic atomizer according to claim 7, wherein an inner diameter of the vapor channel is consistent.

10. The ultrasonic atomizer according to claim 1, wherein the sealing member comprises an airflow guide portion; and
the airflow guide portion at least comprises an airflow guide surface that is obliquely arranged relative to the atomization surface, to cause external air to flow toward the atomization surface through guidance of the airflow guide surface after the external air enters the sealing member.

11. The ultrasonic atomizer according to claim 1, wherein the sealing member comprises a through hole that is in fluid communication with the liquid storage cavity, and the liquid guide element further comprises a part extending in the through hole; and an inner wall of the through hole comprises a capillary trench that is provided adjacent to the liquid storage cavity.

12. The ultrasonic atomizer according to claim 1, wherein the sealing member comprises a through hole that is in fluid communication with the liquid storage cavity, and the liquid guide element further comprises a part extending in the through hole; and a part of the through hole that is adjacent to the liquid guide element comprises at least one avoidance space.

13. The ultrasonic atomizer according to claim 1, wherein the sealing member comprises an inclined surface, and the inclined surface supports a liquid absorbing section of the liquid guide element, to cause the liquid absorbing section to stay in contact with the liquid storage cavity.

14. The ultrasonic atomizer according to claim 1, wherein the liquid guide element comprises a first liquid guide element and a second liquid guide element; the first liquid guide element is in fluid communication with the liquid storage cavity to absorb the liquid substrate; and the second liquid guide element stays in contact with the first liquid guide element, and stays in contact with the atomization surface under an abutting action of the sealing member to transmit the liquid substrate onto the atomization surface.

15. An ultrasonic atomization device, comprising a power supply assembly and the ultrasonic atomizer according to claim 1.

16. The ultrasonic atomization device according to claim 15, wherein the sealing member has run-through hollow to form a vapor channel, and the vapor channel comprises a first end and a second end opposite to the first end; and
an end portion of the second end stays in contact with the at least a part of the liquid guide element, to abut the at least a part of the liquid guide element against the atomization surface.

17. The ultrasonic atomization device according to claim 16, wherein an inner wall of the vapor channel and the atomization surface jointly define an atomization chamber.

18. The ultrasonic atomization device according to claim 16, wherein an inner wall of the vapor channel is roughly flat.

19. The ultrasonic atomization device according to claim 16, wherein the end portion of the second end is locally recessed to form a notch groove.

20. The ultrasonic atomization device according to claim 16, wherein the end portion of the second end is locally recessed to form an airflow groove.
